(19) United States
(12) Patent Application Publication
(10) Pub. No.: US 2026/0020112 A1
(43) Pub. Date: Jan. 15, 2026

(54) Method of Cooking a Packaged Cooking Product

(71) Applicant: RATIONAL Aktiengesellschaft, Landsberg am Lech (DE)

(72) Inventors: Martin HEINRICH, Landsberg am Lech (DE); Lilly-Marie SCHMIDT, Landsberg am Lech (DE)

(21) Appl. No.: 19/264,123

(22) Filed: Jul. 9, 2025

(30) Foreign Application Priority Data
Jul. 12, 2024 (DE) 10 2024 119 876.1

(51) Int. Cl. H05B 1/02; A47J 27/04

(52) U.S. Cl. CPC H05B 1/0261; A47J 2027/043

(57) ABSTRACT

Embodiments of the present disclosure relate to a method of cooking a cooking product packaged in a package in a cooking appliance comprising a heating device and a fan, the method comprising the following steps: a) specifying a package-specific limit value for the package of the cooking product; b) determining, on the basis of the package-specific limit value, a permissible parameter range for a fan speed of the fan and a cooking chamber temperature, the fan speed and the cooking chamber temperature being dependent on each other within the permissible parameter range; and c) controlling the fan and the heating device so that the fan speed and the cooking chamber temperature are within the permissible parameter range. Embodiments of the present disclosure also relate to a cooking appliance which is set up to carry out the above method.

Embodiments of the present disclosure relate to a method of cooking a cooking product packaged in a package in a cooking appliance. Furthermore, embodiments of the present disclosure relate to a cooking appliance.

### CROSS-REFERENCE TO RELATED APPLICATIONS AND PRIORITY

This patent application claims priority from German Patent Application No. 10 2024 119 876.1 filed Jul. 12, 2024. This patent application is herein incorporated by reference in its entirety.

### BACKGROUND OF THE INVENTION

In professional and large-scale kitchens, cooking appliances are used which can cook a cooking product arranged in a cooking chamber of the cooking appliance in different ways. Cooking methods which cook the cooking product by means of hot air and/or steam are usually used. Modern cooking appliances increasingly use microwave sources which feed microwave radiation into the cooking chamber to introduce (additional) energy into the cooking product.

The cooking product is usually cooked unpackaged and then offered directly for consumption. However, the preparation of packaged cooking products becomes increasingly important. In particular, packaged cooking products may be handled more hygienically and offered directly for consumption without prior portioning, for example at so-called “grab and go” counters.

However, some challenges arise when preparing packaged cooking products in modern cooking appliances. For example, the package surrounding the cooking product must be taken into account when setting the process parameters for the cooking process. In particular, it must be ensured that the package is not damaged by the cooking chamber atmosphere, especially by the energy input into the package.

Manual setting of the process parameters taking the package into account is extremely difficult and error-prone for the user, as he has to rely on experience to estimate the influence of the process parameters on the package. This is made more difficult by the fact that many process parameters are interdependent and influence each other, so that it is not always possible to predict how the process parameters will affect the cooking process and the package.

### BRIEF DESCRIPTION OF THE INVENTION

In this respect, the object of the present disclosure is to provide a method of cooking a packaged cooking product which enables reliable input of the process parameters to cook a packaged cooking product taking the package into account.

The object is achieved according to the present disclosure by a method of cooking a cooking product packaged in a package in a cooking appliance comprising a heating device and a fan, the method comprising the following steps:
a) specifying a package-specific limit value for the package of the cooking product;
b) determining, on the basis of the package-specific limit value, a permissible parameter range for a fan speed of the fan and a cooking chamber temperature, the fan speed and the cooking chamber temperature being dependent on each other within the permissible parameter range; and
c) controlling the fan and the heating device so that the fan speed and the cooking chamber temperature are within the permissible parameter range.

The method according to the present disclosure is based on the basic idea of simply specifying a package-specific limit value as the starting point to the cooking appliance, on the basis of which the cooking appliance automatically determines a permissible parameter range for the fan speed and the cooking chamber temperature in step b), so that a user does not have to deal with the setting of these process parameters with regard to the application safety of the package. The application safety of the package is ensured by the fact that, in step c), the cooking appliance controls the fan and the heating device on the basis of the permissible parameter range such that the package-specific limit value for the package of the cooking product is not exceeded. This reduces the susceptibility to errors for entering the process parameters, and the packaged cooking product can be cooked easily, taking the package into account.

The permissible parameter range is a working window in which the cooking chamber temperature and the fan speed can be freely regulated without compromising the application safety of the package, which means that the package does not soften, break apart, break through, and/or cause a material change in the package material used in the package.

In particular, it has been recognized that heat flow in the package depends both on the cooking chamber temperature and the fan speed of the fan, which is why both parameters are taken into account. However, these relationships are not intuitively comprehensible to a user of the cooking appliance, which is why incorrect conditions would arise. By taking the package-specific limit value and the parameter range for the fan speed and the cooking chamber temperature determined automatically on this basis into account, it can therefore be ensured that the package is not damaged, in particular that it is not exposed to excessive energy input.

According to a first aspect of the present disclosure, it is provided that the package-specific limit value is specified to the cooking appliance by means of a sensor or via a user interface. This allows the package-specific limit value to be easily made available to the cooking appliance for automatic further processing by the cooking appliance.

The sensor is preferably a code sensor, for example a 2D code sensor or an RFID sensor. These sensors can read different types of codes which are for example applied to the package of the cooking product to be cooked in the form of a barcode, QR code or RFID tag. This allows the package-specific limit value to be detected by the cooking appliance in a particularly user-friendly manner.

According to a further aspect of the present disclosure, it is provided that the permissible parameter range is determined based on a model, a functional relationship or a table, in particular using empirical data, depending on the package-specific limit value. For example, the model, functional relationship or table can be determined empirically in advance for different types of cooking appliances, cooking products and packages and then stored in a database or a memory of the cooking appliance. This allows the permissible parameter range for a fan speed of the fan and a cooking chamber temperature to be determined particularly reliably and time-efficiently. The database may also be provided externally to the cooking appliance, in particular on a server or in a cloud (cloud server), wherein the cooking appliance can access the database. The model may be a deterministic model which incorporates several parameters. The model may also be a model based on artificial intelligence, e.g., a machine learning model which includes at least the package-specific limit value for the package of the cooking product as an input variable and the permissible parameter range for the fan speed of the fan and the cooking chamber temperature as output variables. In this respect, the model may be a statistical model.

A further aspect of the present disclosure provides that the package-specific limit value is a specified heat limit value or a specified temperature limit value. It has been found that a heat limit value or a temperature limit value represents a particularly favorable starting point for reliably determining the permissible parameter range for the fan speed of the fan and the cooking chamber temperature based thereon.

According to a further aspect of the present disclosure, it is provided that the heat limit value is determined on the basis of the specified temperature limit value, taking at least one heat flow-relevant parameter into account. The heat flow-relevant parameter may be a heat transfer coefficient or a heat-absorbing product surface of the package of the cooking product to be cooked. In particular, the heat limit value is a maximum permissible heat flow density value for the package of the cooking product to be cooked. This aspect is based on the knowledge that the heat limit value represents a starting point which if favorable in terms of control and from which the permissible parameter range can be determined particularly easily.

According to a further aspect of the present disclosure, it is provided that the permissible parameter range is determined based on a maximum permissible heat flow density for the package of the cooking product to be cooked. The maximum permissible heat flow density is preferably used in a model, a functional relationship, or a table, in particular based on empirical data, to determine the permissible parameter range. For example, the maximum permissible heat flow density may be correlated with the parameters fan speed and cooking chamber temperature to obtain a permissible parameter range in the form of a working window, in which they can be regulated without compromising the application safety of the package. Consequently, the permissible parameter range is defined by the maximum permissible heat flow density value, which represents the maximum permissible heat flow or heat flux per package surface, i.e., the maximum energy flow which may be transferred to the packaged cooking product by the cooking chamber temperature and the fan speed at a given time to prevent damage to the package.

A further aspect of the present disclosure provides that, when determining the permissible parameter range, the cooking appliance takes at least one package-related parameter into account in addition to the package-specific limit value. The package-related parameter may be, for example, the weight of the packaged cooking product including the package, a cooking product-specific characteristic value of the cooking product to be cooked, or a material-specific characteristic value of the package of the cooking product to be cooked, preferably a moisture limit value or a microwave limit value. The permissible parameter range can be determined even more precisely using the aforementioned package-related parameters, which makes the method more reliable overall. The amount of heat which can be absorbed by the packaged cooking product can depend on the weight of the packaged cooking product and a cooking product-specific characteristic value of the cooking product to be cooked, which in turn influences the amount of heat energy to which the package is exposed. Similarly, the material-specific characteristic value of the package can have a corresponding influence, for example if the packaged cooking product is thermally shielded.

A further aspect of the present disclosure provides that a minimum value for the fan speed of the fan and/or the cooking chamber temperature is specified, in particular depending on a cooking program based on which the cooking product is cooked in the cooking appliance. Due to the minimum value for the fan speed of the fan, it can advantageously be ensured that no stratification of different temperature zones occurs in the cooking chamber. The cooking product is thus cooked particularly evenly, regardless of the position in the cooking chamber. A minimum value for the cooking chamber temperature ensures that the cooking product is cooked reliably, depending on the type of cooking product.

A further aspect of the present disclosure provides that the permissible parameter range additionally includes a value for the cooking chamber humidity, the cooking chamber humidity, the fan speed, and the cooking chamber temperature depending on each other within the permissible parameter range, and a steam generator being additionally driven such that the cooking chamber humidity is within the permissible parameter range. In simple terms, a value for the cooking chamber humidity is now additionally added to the parameters fan speed and cooking chamber temperature parameters, which increases the number of control options for the cooking appliance in step c). Furthermore, moisture-sensitive packages can be taken into account, e.g., packages made from renewable raw materials such as cardboard, so that these do not become soggy during the cooking process due to excessive cooking chamber humidity. In principle, the cooking chamber humidity, the fan speed, and the cooking chamber temperature define the heat transfer in the cooking chamber in a convection-based (using hot air and/or steam) cooking process, so that these parameters are dependent on each other within the permissible parameter range. The heat flow in the package depends on the heat transfer in the cooking chamber, as the package surrounding the packaged cooking product is located in the cooking chamber in which the heat transfer takes place.

Embodiments of the present disclosure furthermore relate to a cooking appliance for cooking a packaged cooking product, comprising a cooking chamber, the cooking appliance having a heating device and a fan which generate a cooking chamber atmosphere in the cooking chamber. In addition, the cooking appliance comprises a temperature sensor for detecting a cooking chamber temperature and an evaluation unit which is connected to the temperature sensor in a signal-transmitting manner. The evaluation unit is set up to receive a package-specific limit value for the package of the cooking product and, based on the package-specific limit value, to determine a permissible parameter range for the fan speed of the fan and a cooking chamber temperature, the fan speed and the cooking chamber temperature being dependent on each other within the permissible parameter range. Furthermore, the cooking appliance has a control unit which is connected to the evaluation unit in a signal-transmitting manner, the control system being set up to drive the fan and the heating device so that the fan speed and the cooking chamber temperature are within the permissible parameter range. The advantages discussed in relation to the method apply to the cooking appliance accordingly.

### BRIEF DESCRIPTION OF THE FIGURES

Further features and advantages of the embodiments of the present disclosure will become apparent from the description below and from the drawings to which reference is made and in which:

FIG. 1 shows a schematic representation of a cooking appliance according to the present disclosure, loaded with a packaged cooking product;

FIG. 2 shows a schematic flow diagram of the steps for carrying out a method according to the present disclosure of cooking a cooking product packaged in a package; and

FIG. 3 shows a representation of a functional relationship between the heat flow density, the cooking chamber temperature, and the fan speed.

### DETAILED DESCRIPTION OF THE FIGURES

FIG. 1 shows a cooking appliance 10 having a cooking chamber 12. The cooking chamber 12 is loaded with a cooking product 14 arranged on a cooking product carrier 16, e.g., a tray. The cooking product carrier 16 can be inserted into the cooking chamber 12 via various racks 18, i.e. at different levels.

As can be clearly seen in FIG. 1, the cooking product 14 is surrounded by a package 20 which at least partially, preferably completely, encloses the cooking product 14. The package 20 may be provided with perforations (not shown here) to allow exchange between the cooking chamber atmosphere in the cooking chamber 12 and the cooking product 14. However, it may also be provided that the package 20 has no perforation, as a result of which a microatmosphere for the cooking product 14 can form inside the package 20, which depends on the cooking atmosphere in the cooking chamber 12.

The package 20 is made of a package material which is basically suitable for cooking in the cooking chamber 12. A plastic such as polyethylene or polypropylene can be used as a package material. However, the package material can also be made from a renewable raw material such as cardboard. Mixed packages made from plastic and cardboard are of course also conceivable. Packages 20 intended for single use rather than repeated use are preferred.

In addition to the cooking chamber 12, a technical compartment 22 is provided in the cooking appliance 10, in which various devices for cooking the cooking product 14 are accommodated.

The technical compartment 22 comprises at least partially a heating device 24, which is set up to supply hot air to the cooking chamber 12 so that a specific cooking chamber temperature is set in the cooking chamber 12.

Optionally, a steam generator 26 and a microwave source 28 can be accommodated at least partially in the technical compartment 22 in addition to the heating device 24. The steam generator 26 serves to provide a specific cooking chamber humidity in the cooking chamber 12. The microwave source 28 can feed microwave radiation into the cooking chamber 12 to additionally supply the packaged cooking product 14 with energy. The microwave source 28 can be, for example, a magnetron or a semiconductor component.

In addition, a fan 30 is arranged in the cooking chamber 12, which can be controlled by a control unit 32 housed in the technical compartment 22, which also drives the heating device 24, the steam generator 26, and the microwave source 28, so that the control unit 32 can generate a specific cooking chamber atmosphere in the cooking chamber 12 for cooking the packaged cooking product 14.

Furthermore, at least one temperature sensor 34 is arranged in the cooking chamber 12 to monitor the cooking chamber temperature. The temperature sensor 34 is connected to an evaluation unit 40, which is also arranged in the technical compartment 22.

If the steam generator 26 and the microwave source 28 are installed, the cooking chamber 12 also comprises a humidity sensor 36 for monitoring the cooking chamber humidity, and a microwave sensor 38 for monitoring the microwave radiation fed in, in particular the microwave power or the microwave energy fed in. Both sensors 36, 38 are each connected in a signal-transmitting manner to the evaluation unit 40 housed in the technical compartment 22.

The evaluation unit 40 is also set up to receive a package-specific limit value for the package of the cooking product 14 and, based on the package-specific limit value, to determine a permissible parameter range for the fan speed of the fan 30 and a cooking chamber temperature, the fan speed and the cooking chamber temperature being dependent on each other within the permissible parameter range.

For this purpose, the evaluation unit 40 of the cooking appliance 10 is connected to the control unit 32 in a signal-transmitting manner, the control unit 32 being set up to drive the fan 30 and the heating device 24 based on the permissible parameter range specified by the evaluation unit 40 such that the cooking chamber temperature and the fan speed are within the permissible parameter range.

It is also conceivable that the evaluation unit 40 and the control unit 32 are designed as a single unit, i.e., as a combined control and evaluation unit.

The evaluation unit 40 is further connected in a signal-transmitting manner to a sensor 42 and a user interface 44. The latter can be used to specify the package-specific limit value to the cooking appliance 10.

For example, the user interface 44 can be designed as a touch screen via which a user can manually enter the package-specific limit value.

Alternatively and/or additionally, the user can specify the package-specific heat limit value to the cooking appliance 10 via the sensor 42, for example in that the user specifies a code printed on the package 20, in particular a barcode, to the cooking appliance 10 by means of the sensor 42. The sensor 42 is preferably designed as a code sensor, in particular as a 2D code sensor, or an RFID sensor, the corresponding (2D) code being printed on the package 20 or an RFID tag being integrated into the package 20.

Of course, the sensor 42 can also be arranged inside the cooking chamber 12 and be set up to automatically read a code applied to the package 20.

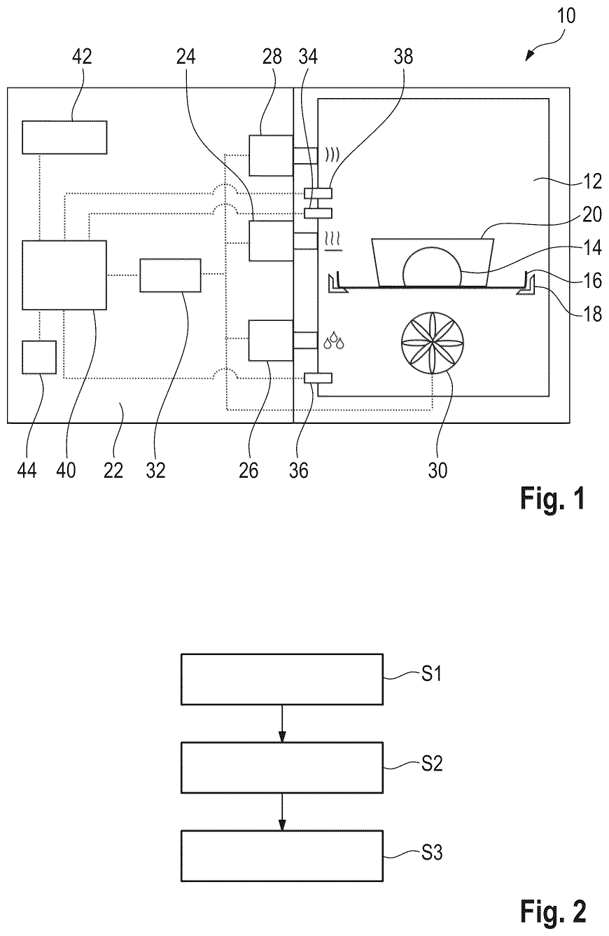

A method of cooking a cooking product 14 packaged in a package 20 is explained below with reference to FIG. 2.

At the start of the method, the cooking product 14 packaged in a package 20 is placed in the cooking chamber 12 and/or is already located therein.

In a first step S1, a package-specific limit value for the package 20 of the cooking product 14 is specified to the cooking appliance 10.

In particular, the package-specific limit value can be specified to the cooking appliance 10 by specifying the package-specific limit value by means of the sensor 42. The sensor 42 can detect a (2D) code applied to the package 20 or read an RFID tag to obtain the package-specific limit value. The package-specific limit value can also be entered manually via the user interface 44.

The package-specific limit value is preferably a specified heat limit value or a specified temperature limit value of the package 20.

In step S1, a temperature limit value, a heat transfer coefficient, and a product surface of the package 20 are preferably specified to the cooking appliance 10. This data can be encoded together in the form of a (2D) code or by means of an RFID tag, which is detected by the sensor 42. However, it is also conceivable that the user specifies this data manually to the cooking appliance 10 via the user interface 44. In particular, the data can be encoded together in a representative value so that the user only has to make a single entry.

In a next step S2, a permissible parameter range for the fan speed of the fan 30 and a cooking chamber temperature are determined on the basis of the package-specific limit value, the fan speed and the cooking chamber temperature being dependent on each other within the permissible parameter range.

In other words, a value range is determined for the fan speed, which determines a corresponding value range for the cooking chamber temperature, as the fan speed and the cooking chamber temperature are dependent on each other within the permissible parameter range.

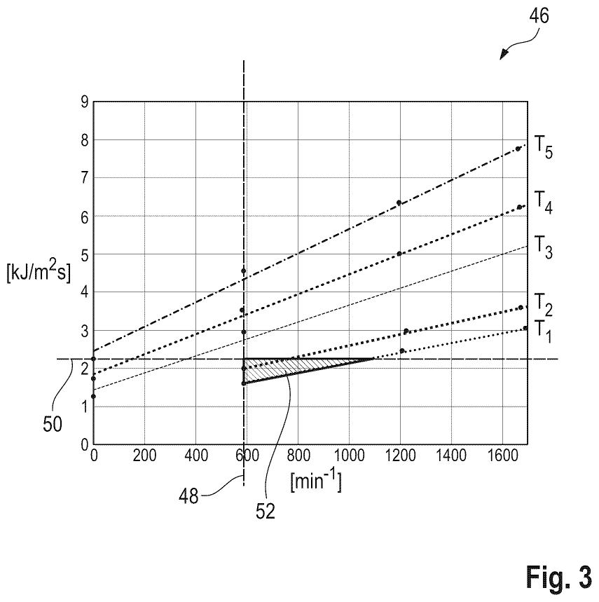

For example, the permissible parameter range can be determined based on a model, a functional relationship, or a table, in particular on the basis of empirical data depending on the package-specific limit value. Such a functional relationship 46 is shown, for example, in FIG. 3, which is explained in detail below.

To correlate the cooking chamber temperature and the fan speed with the package-specific limit value using a model, a functional relationship or a table, it is advantageous to first convert it into a value which represents a maximum permissible amount of energy which may be transferred to the package 20 without compromising the application safety of the package 20.

For this purpose, the heat limit value is advantageously determined on the basis of the specified temperature limit value and taking at least one heat flow-relevant parameter into account. This can be carried out by the evaluation unit 40. A heat transfer coefficient and/or a heat-absorbing product surface of the package 20 of the cooking product 14 to be cooked can be used as a heat flow-relevant parameter, for example.

The evaluation unit 40 can determine a maximum permissible heat flow density value for the package 20 of the cooking product 14 to be cooked from the temperature limit value, the heat transfer coefficient, and the product surface of the package 20. In contrast to the heat limit value, the maximum permissible heat flow density value takes not only the heat transfer coefficients into account but also the product surface of the package 20 of the cooking product 14 to be cooked.

The maximum permissible heat flow density value can be determined by an evaluation unit 40, preferably based on the following formula:

$$\dot{q} = α ( D Z ) \cdot ( G T - {T}_{0} )$$

where \dot{q} is the heat flow density, thus corresponds to

$$\frac{\dot{Q}}{A} ,$$

A being the neat-absorbing product surface of the package 20 of the cooking product to be cooked 14 and \dot{Q} being a heat flow. α(DZ) is a heat transfer coefficient dependent on the speed of the cooking appliance 10 used, GT is the cooking chamber temperature and T₀ is the temperature limit value.

For example, the heat-absorbing product surface of the package 20 and the heat transfer coefficient α(DZ) may be values stored in advance in the evaluation unit 40, which can be used during step S2 to obtain the heat flow density value. These values are preferably stored in a database or memory (not shown) of the evaluation unit 40. Alternatively, as already described above, these values can also be specified to the cooking appliance 10 in step S1.

As already explained above, there is no need to determine the heat flow density value using the evaluation unit 40 and the above formula if a maximum permissible heat flow density value is directly specified to the cooking appliance 10 in step S1.

The maximum permissible heat flow density value can be used to determine the permissible parameter range for the package 20 of the cooking product 14 to be cooked. For this purpose, the evaluation unit 40 can, for example, refer to a model, a table or a functional relationship to correlate the maximum permissible heat flow density value with the cooking chamber temperature and the fan speed, as shown in FIG. 3, to which reference is made below.

FIG. 3 shows a functional relationship 46 in the form of a diagram in which the heat flow density is plotted on the Y-axis and an average speed of the fan wheel 30 is plotted on the X-axis.

Furthermore, the linear relationship between the average speed and a cooking chamber temperature is shown, which is reflected in the various straight lines, five of which are shown as examples. Each of the straight lines is assigned to a cooking chamber temperature Tₓ, where T₁<T₂, T₂<T₃, T₃<T₄ and T₄<T₅. The straight lines have different Y-axis sections. In this specific case, T₁=80° C., T₂=90° C., T₃=120° C., T₄=140° C. and T₅=160° C.

The functional relationship 46 shown in FIG. 3 can, for example, be determined in advance experimentally for the respective cooking appliance 10 and stored in the evaluation unit 40. To this end, it is sufficient to collect only a few data points. The values between the determined data points for the straight lines can be easily interpolated and/or extrapolated so that the functional relationship takes any cooking chamber temperature into account.

Furthermore, a vertical axis 48 is drawn in the diagram in FIG. 3 as a dashed line, which represents a minimum speed which limits the average speed downwards at temperatures T₁ and T₂ to ensure an even temperature distribution in the cooking chamber 12.

A horizontal line is also drawn to mark the package-specific limit value 50 in the form of a maximum permissible heat flow density value. In addition, a minimum value for the cooking chamber temperature can also be specified (not shown here).

The diagram in FIG. 3 shows that the line for the package-specific limit value 50, i.e. the maximum permissible heat flow density value, defines a parameter range in the form of a working window 52 in which the speed and the cooking chamber temperature can be freely selected without exceeding the package-specific limit value 50.

The working window 52 thus represents the permissible parameter range in which the fan speed and the cooking chamber temperature can be regulated. The fan speed and the cooking chamber temperature are dependent on each other in the permissible parameter range, since the temperature T₁ is possible for a larger range of fan speeds than the temperature T₂. Depending on the specification for the minimum temperature and the minimum speed, the shape of the working window 52 and thus the permissible parameter range may change. In this specific case, the working window is triangular in shape.

For example, with a maximum permissible heat flow density value of 2.2 KJ/m²s, a cooking chamber temperature T₁ of 80° C. and an average speed of 600 min⁻¹ could be determined by the evaluation unit 40 and forwarded to the control unit 32 so that it sets the selected parameters in the cooking chamber 12. Alternatively, the evaluation unit 40 could also set a temperature T₁ of 80° C. and a maximum speed of 1,100 min⁻¹ based on the functional relationship 46 without exceeding the maximum permissible heat flow density value. A temperature T₂ of 90° C. and an average speed of 600 min⁻¹ to 750 min⁻¹ would also be conceivable. Of course, temperatures between T₁ and T₂ and corresponding average speeds could also be selected, as long as the permissible parameter range in the form of the working window 52 is not exceeded.

The functional relationship 46 in the form of the diagram shows that different combinations of process parameters can be selected in a simple manner without leaving the permissible parameter range and exceeding the package-specific limit value. The application safety of the package 20 is thus always ensured. Instead of a functional relationship 46, a model or a table can also be stored in the evaluation unit 40.

In addition, the permissible parameter range can include a value for the cooking chamber humidity, the cooking chamber humidity, the fan speed, and the cooking chamber temperature being dependent on each other within the permissible parameter range. In this case, the 2D diagram shown would become a 3D diagram. Similarly, the permissible parameter range can additionally include a value for the microwave power, the microwave power, the fan speed, and the cooking chamber temperature being dependent on each other within the permissible parameter range. Of course, the permissible parameter range can also take the microwave power, the cooking chamber humidity, the fan speed, and the cooking chamber temperature into account together.

Furthermore, in step S2, when determining the permissible parameter range, at least one package-related parameter can be taken into account, in particular a weight of the packaged cooking product including the package, a cooking product-specific characteristic value of the cooking product to be cooked or a material-specific characteristic value of the package of the cooking product to be cooked, preferably a moisture limit value or a microwave limit value. The package-specific limit value can be specified to the cooking appliance 10 via the user interface 44 or the sensor 42.

In a final step S3, which is shown again in FIG. 2, the fan 30 and the heating device 24 are driven by the control unit 32 in accordance with the permissible parameter range. For this purpose, the evaluation unit 40 can limit the control options of the control unit 32 to the permissible parameter range so that it can only drive the fan 30 and the heating device 24 such that the fan speed and the cooking chamber temperature are within the permissible parameter range. The steam generator 26 and the microwave source 28, if present, can also be driven by the control unit 32 accordingly.

1. A method of cooking a cooking product packaged in a package in a cooking appliance comprising a heating device and a fan, the method comprising the following steps:
a) specifying a package-specific limit value for the package of the cooking product;
b) determining, on the basis of the package-specific limit value, a permissible parameter range for a fan speed of the fan and a cooking chamber temperature, the fan speed and the cooking chamber temperature being dependent on each other within the permissible parameter range; and
c) controlling the fan and the heating device so that the fan speed and the cooking chamber temperature are within the permissible parameter range.

2. The method according to claim 1, wherein the package-specific limit value is specified to the cooking appliance by entering the package-specific limit value into the cooking appliance from a sensor.

3. The method according to claim 2, wherein the sensor is a 2D code sensor or an RFID sensor.

4. The method according to claim 1, wherein the package-specific limit value is specified to the cooking appliance by entering the package-specific limit value via a user interface.

5. The method according to claim 1, wherein the permissible parameter range is determined based on a model, a functional relationship, or a table depending on the package-specific limit value.

6. The method according to claim 1, wherein the package-specific limit value is a specified heat limit value or a specified temperature limit value.

7. The method according to claim 6, wherein a heat limit value is determined on the basis of the specified temperature limit value and taking at least one heat flow-relevant parameter into account.

8. The method according to claim 7, wherein the heat limit value is a maximum permissible heat flow density value for the package of the cooking product to be cooked.

9. The method according to claim 7, wherein the heat flow-relevant parameter is a heat transfer coefficient or a heat-absorbing product surface of the package of the cooking product to be cooked.

10. The method according to claim 1, wherein the permissible parameter range is determined based on a maximum permissible heat flow density value for the package of the cooking product to be cooked.

11. The method according to claim 1, wherein the cooking appliance takes at least one package-related parameter into account in addition to the package-specific limit value when determining the permissible parameter range.

12. The method according to claim 1, wherein the package-related parameter is a weight of the packaged cooking product including the package, a material-specific characteristic value of the package of the cooking product to be cooked, preferably a moisture limit value, a microwave limit value, or a cooking product-specific characteristic value of the cooking product to be cooked.

13. The method according to claim 1, wherein a minimum value for the fan speed of the fan and/or the cooking chamber temperature is specified.

14. The method according to claim 13, wherein the minimum value is specified depending on a cooking program based on which the cooking product is cooked in the cooking appliance.

15. The method according to claim 1, wherein the permissible parameter range additionally comprises a value for a cooking chamber humidity, the cooking chamber humidity, the fan speed, and the cooking chamber temperature being dependent on each other within the permissible parameter range, and a steam generator being additionally driven such that the cooking chamber humidity lies within the permissible parameter range.

16. A cooking appliance for cooking a packaged cooking product, comprising a cooking chamber, the cooking appliance having a heating device and a fan which generate a cooking chamber atmosphere in the cooking chamber, the cooking appliance furthermore comprising a temperature sensor for detecting a cooking chamber temperature,
the cooking appliance having an evaluation unit which is connected to the temperature sensor in a signal-transmitting manner,
the evaluation unit being set up to receive a package-specific limit value for the package of the cooking product and to determine a permissible parameter range for a fan speed of the fan and a cooking chamber temperature based on the package-specific limit value, the fan speed and the cooking chamber temperature being dependent on each other within the permissible parameter range,
and the cooking appliance having a control unit which is connected to the evaluation unit in a signal-transmitting manner, the control unit being set up to drive the fan and the heating device so that the fan speed and the cooking chamber temperature are within the permissible parameter range.
